(19) United States
(12) Patent Application Publication
(10) Pub. No.: US 2011/0236856 A1
(43) Pub. Date: Sep. 29, 2011

(54) REMOVABLE DENTURE AND METHOD OF PRODUCING THE SAME

(76) Inventors: Manabu Kanazawa, Kanagawa (JP); Shunsuke Minakuchi, Kanagawa (JP); Yusuke Sato, Tokyo (JP); Kei Ohya, Tokyo (JP); Masanao Inokoshi, Tokyo (JP)

(21) Appl. No.: 13/130,300

(22) PCT Filed: Nov. 19, 2009
(86) PCT No.: PCT/JP2009/069652

§ 371 Date: Jun. 14, 2011

(30) Foreign Application Priority Data
Nov. 20, 2008 (JP) 2008-297080

(51) Int. Cl. A61C 13/007

(52) U.S. Cl. 433/199.1

(57) ABSTRACT

A removable denture includes a denture base that is made of ultrahigh molecular weight polyethylene and is formed in a predetermined shape by a molded object of ultrahigh molecular weight polyethylene being cut; and artificial teeth that are arrayed at the denture base.

### TECHNICAL FIELD

The present invention relates to a removable denture and a method of producing the same.

### BACKGROUND ART

A removable denture is a denture in which artificial teeth are implanted in a denture base that is the foundation. A removable denture is fit into an oral cavity by the mucosal surface of the denture base being tightly fit to the oral mucosa, and compensates for functions that have been lost due to loss of natural teeth. Removable dentures include partial removable dentures and full removable dentures, and full removable dentures are also called full dentures. Full dentures are fabricated for toothless jaws at which all natural teeth have been lost.

There are metal bases and resin bases as types of the denture base. From the standpoint of ease of fabricating the denture and biocompatibility, resin bases formed from acrylic resins such as poly(methyl methacrylate) (PMMA) and the like are widely used. Artificial teeth include resin teeth, porcelain teeth, and metal teeth. When a resin base is used, resin teeth that are formed from the same acrylic resin are often used because of good adhesiveness.

In accordance with the disclosure of Japanese Patent Application Laid-Open (JP-A) No. 11-139919 (Patent Document 1), conventionally, there is an example that uses an engineering plastic as the resin for the base, in order to reproduce a design that approximates the capillary vessels of the gums. However, these engineering plastics have not become popular as resins for bases because of the ease of dealing with PMMA such as the moldability and cost and the like. Further, a denture base formed of PMMA is generally molded by an embedding-inlay method (injection molding), and therefore, there are only a few examples that apply CAD/CAM technology to the fabrication of a denture base, such as JP-A No. 6-78937 (Patent Document 2), JP-A No. 6-304190 (Patent Document 3).

For example, a method of fabricating a removable denture is proposed in JP-A No. 6-78937, in which the surface shape of an impression material that takes a precise impression is measured without contact by using a three-dimensional measuring device using light illumination, the jaw ridge shape that has been made into electronic data is acquired, a shape model of a denture base is fabricated from the jaw ridge shape by CAD, and a removable denture is fabricated by optical molding.

A method is proposed in JP-A No. 6-304190 of acquiring a jawbone shape by a non-invasive measuring method such as X-ray CT imaging or the like, acquiring the surface shape of the mucosal surface within the oral cavity from a precise impression taken by using an impression material, correcting the surface shape of the mucosal surface by CAD on the basis of the jawbone shape and designing a shape model of the denture base, and fabricating the denture base at an NC machine tool by CAM.
[Patent Document 1] JP-A No. 11-139919
[Patent Document 2] JP-A No. 6-78937
[Patent Document 3] JP-A No. 6-304190

### DISCLOSURE OF INVENTION

### Problem to be Solved by the Invention

However, conventional resin base dentures that are formed from acrylic resin have the problems that they break more easily and it is easier for fouling substances to adhere thereto than metal base dentures. As fouling substances of dentures, there are food residue, denture plaque, stains (settling of dyestuffs), dental calculus, and the like, and it is difficult to remove all of these only by washing with water. In particular, the use of toothpaste for dentures or a denture cleanser is needed in order to remove stains. Leaving fouling substances of dentures alone is not preferable from the standpoint of aesthetics. Further, this also leads to propagation of bacteria within the oral cavity, and is not preferable also from the standpoint of oral hygiene.

Further, in the conventional methods of fabricating a removable denture that are disclosed in JP-A No. 6-78937 or JP-A No. 6-304190, because the shape model of the denture base is designed from the jaw ridge shape or the jawbone shape, design errors are great, and it is supposed that it is difficult to produce a denture base that is actually suited.

The present invention has been made in order to overcome the above-described problems, and an object of the present invention is to provide a removable denture to which it is difficult for fouling substances to adhere, and, even if fouling substances do adhere, the fouling substances can easily be removed, and that has excellent durability. Another object of the present invention is to provide a method of producing a removable denture that can accurately produce a removable denture.

### Means for Solving the Problem

In order to achieve the above-described object, the invention according to claim 1 is a removable denture including: a denture base that is made of ultrahigh molecular weight polyethylene and is formed in a predetermined shape by a molded object of ultrahigh molecular weight polyethylene being cut; and artificial teeth that are arrayed at the denture base.

The invention of claim 2 is the removable denture according to claim 1, wherein the artificial teeth are adhered to recesses for an artificial teeth array that are formed in a surface of the denture base.

The invention of claim 3 is the removable denture according to claim 2, wherein the artificial teeth are resin teeth made of acrylic resin, and after at least the recesses of the denture base are surface-modified so as to be able to adhere with acrylic resin, the artificial teeth are adhered to the surface-modified recesses.

The invention of claim 4 is the removable denture according to claim 3, wherein the recesses of the denture base are surface-modified by impregnating, in the recesses, an impregnant having affinity with respect to ultrahigh molecular weight polyethylene, introducing hydrophilic groups into a surface of the ultrahigh molecular weight polyethylene that has been impregnated with the impregnant, and graft polymerizing a hydrophilic monomer at the surface of the ultrahigh molecular weight polyethylene at which the hydrophilic groups have been introduced.

The invention of claim 5 is the removable denture according to claim 3 or 4, wherein the acrylic resin is poly(methyl methacrylate) (PMMA).

The invention of claim 6 is a removable denture including a denture base and artificial teeth arrayed at the denture base, wherein the denture base and the artificial teeth are formed integrally in a predetermined shape by a molded object of ultrahigh molecular weight polyethylene being cut.

The invention of claim 7 is the removable denture according to any one of claims 1 through 6, wherein a water absorption rate of the ultrahigh molecular weight polyethylene is less than or equal to 0.01 wt %.

The invention of claim 8 a method of producing a removable denture that produces the removable denture according to claims 1 through 5 and 7, the method including steps of: forming the denture base into the predetermined shape by cutting the molded object of ultrahigh molecular weight polyethylene on the basis of three-dimensional shape information of the denture base; surface-modifying recesses for an artificial teeth array, that are formed in a surface of the denture base, so as to be able to adhere with acrylic resin; and adhering the artificial teeth to the surface-modified recesses.

The invention of claim 9 is the method of producing a removable denture according to claim 8, further including steps of: carrying out imaging of an old denture after correction at which a form of a mucosal surface and an occlusion height have been corrected, and acquiring imaging data of the old denture after correction; carrying out imaging of the artificial teeth, and acquiring imaging data of the artificial teeth; displaying a three-dimensional image of the old denture after correction on the basis of the imaging data of the old denture after correction, and displaying a three-dimensional image of the artificial teeth on the basis of the imaging data of the artificial teeth, and carrying out optimization of an artificial teeth array and a form of a mucosal surface in the displayed three-dimensional images, and acquiring three-dimensional shape information of a new denture on the basis of the displayed three-dimensional image of the new denture; and removing artificial teeth from the new denture in the displayed three-dimensional image of the new denture, and acquiring three-dimensional shape information of a denture base of the new denture on the basis of the displayed three-dimensional image of the denture base of the new denture.

The invention of claim 10 is a method of producing a removable denture that produces the removable denture according to claim 6, the method including steps of: forming the denture base and the artificial teeth integrally in the predetermined shape by cutting the molded object of ultrahigh molecular weight polyethylene, on the basis of three-dimensional shape information of the denture having the denture base and the artificial teeth.

The invention of claim 11 is the method of producing a removable denture according to claim 10, further including steps of: carrying out imaging of an old denture after correction at which a form of a mucosal surface and an occlusion height have been corrected, and acquiring imaging data of the old denture after correction; carrying out imaging of the artificial teeth, and acquiring imaging data of the artificial teeth; displaying a three-dimensional image of the old denture after correction on the basis of the imaging data of the old denture after correction, displaying a three-dimensional image of the artificial teeth on the basis of the imaging data of the artificial teeth, carrying out optimization of an artificial teeth array and a form of a mucosal surface in the displayed three-dimensional images, and acquiring three-dimensional shape information of a new denture on the basis of the displayed three-dimensional image of the new denture; and acquiring three-dimensional shape information of the denture having the denture base and the artificial teeth, on the basis of the displayed three-dimensional image of the new denture.

The invention of claim 16 is a method of producing a removable denture that produces a removable denture having a denture base and artificial teeth that are arrayed at the denture base, the method including steps of: forming a resin base of a predetermined shape by cutting on the basis of three-dimensional shape information of the denture base; surface-modifying recesses for an artificial teeth array, that are formed in a surface of the resin base, so as to be able to adhere with resin teeth; and adhering the resin teeth to the surface-modified recesses. Further, the invention of claim 17 is the method of producing a removable denture according to claim 16, further including steps of: carrying out imaging of an old denture, and acquiring imaging data of the old denture; displaying a three-dimensional image of the old denture on the basis of the imaging data of the old denture, and displaying a three-dimensional image of artificial teeth on the basis of data of only the artificial teeth, and acquiring three-dimensional shape information of a new denture on the basis of a three-dimensional image of the new denture that is displayed by the three-dimensional image of the old denture and the three-dimensional image of the artificial teeth; and removing artificial teeth from the new denture in the displayed three-dimensional image of the new denture, and acquiring three-dimensional shape information of a denture base of the new denture. Further, the invention according to claim 18 is the method of producing a removable denture according to claim 16 or 17, further including steps of: carrying out imaging of the artificial teeth, and acquiring imaging data of only the artificial teeth; and carrying out optimization of the artificial teeth array and a form of a mucosal surface in a three-dimensional image that is displayed by a three-dimensional image of an old denture and the three-dimensional image of the artificial teeth, and displaying the three-dimensional image of the new denture. Note that the present Description discloses_a method of producing a removable denture, including steps of: carrying out imaging of an old denture, and acquiring imaging data of the old denture; displaying a three-dimensional image of the old denture on the basis of the imaging data of the old denture, displaying a three-dimensional image of artificial teeth on the basis of data of only the artificial teeth, and acquiring three-dimensional shape information of a new denture on the basis of a three-dimensional image of a new denture that is displayed by the three-dimensional image of the old denture and the three-dimensional image of the artificial teeth; removing artificial teeth from the new denture in the displayed three-dimensional image of the new denture, and acquiring three-dimensional shape information of a denture base of the new denture on the basis of the displayed three-dimensional image of the denture base of the new denture; forming resin into a denture base of a predetermined shape, on the basis of the three-dimensional shape information of the denture base of the new denture; and adhering artificial teeth to recesses for an artificial teeth array that are formed in a surface of the denture base.

The above-described method of producing may further include steps of: correcting a form of a mucosal surface that contacts oral mucosa and an occlusion height of the old denture, by applying a mucosa adjusting agent that adjusts a mucosal surface of a denture base or by base modification of the denture base; carrying out imaging of the artificial teeth, and acquiring the imaging data of only the artificial teeth; and carrying out optimization of an artificial teeth array and a form of a mucosal surface in a three-dimensional image that is displayed by the three-dimensional image of the old denture and the three-dimensional image of the artificial teeth, and displaying the three-dimensional image of the new denture.

Moreover, there is disclosed a method of producing a removable denture, including steps of: carrying out imaging of an old denture, and acquiring imaging data of the old data of the old denture, and displaying a three-dimensional image of artificial teeth on the basis of data of only the artificial teeth, and acquiring three-dimensional shape information of a new denture on the basis of a three-dimensional image of the new denture that is displayed by the three-dimensional image of the old denture and the three-dimensional image of the artificial teeth; acquiring three-dimensional shape information of a denture having a denture base and artificial teeth, on the basis of the displayed three-dimensional image of the new denture; and forming resin integrally into artificial teeth and a denture base of a predetermined shape, on the basis of the three-dimensional shape information of the denture having the denture base and the artificial teeth.

The above-described method of producing may further include steps of correcting a form of a mucosal surface that contacts oral mucosa and an occlusion height of the old denture, by applying a mucosa adjusting agent that adjusts a mucosal surface of a denture base or by base modification of the denture base; carrying out imaging of the artificial teeth, and acquiring the imaging data of only the artificial teeth; and carrying out optimization of an artificial teeth array and a form of a mucosal surface in a three-dimensional image that is displayed by the three-dimensional image of the old denture and the three-dimensional image of the artificial teeth, and displaying the three-dimensional image of the new denture.

### Effect of the Invention

In accordance with the present invention, there can be provided a removable denture to which it is difficult for fouling substances to adhere, and, even if fouling substances do adhere, the fouling substances can easily be removed, and that has excellent durability. Further, in accordance with the present invention, there can be provided a method of producing a removable denture that can accurately produce a removable denture.

### BRIEF DESCRIPTION OF THE DRAWINGS

FIG. 1 is a perspective view showing the exterior of full dentures.

FIG. 2A is a plan view viewing an upper jaw denture from the occlusal surface.

FIG. 2B is a plan view viewing the upper jaw denture from the mucosal surface.

FIG. 3 is a partial sectional view showing a fit-in state of the full dentures.

FIG. 4 is a sectional view showing a state in which an artificial tooth is adhered to a denture base.

FIG. 5A is a process diagram explaining an adhering process of the artificial tooth and the denture base.

FIG. 5B is a process diagram explaining the adhering process of the artificial tooth and the denture base.

FIG. 6 is a three-dimensional image obtained from CT imaging data at the time of CT imaging a patient in whom old dentures are fit.

FIG. 7 is a three-dimensional image obtained from CT imaging data of the upper jaw denture.

FIG. 8A is a photograph image of artificial teeth for front teeth.

FIG. 8B is a photograph image of artificial teeth for molar teeth.

FIG. 9A is a three-dimensional image obtained from CT imaging data of the artificial teeth.

FIG. 9B is a three-dimensional image obtained from CT imaging data of the artificial teeth.

FIG. 10 is a drawing showing a state of designing a three-dimensional shape model of a new full denture.

FIG. 11 is a drawing showing an image 46 of the three-dimensional shape model of the new full denture.

FIG. 12 is a drawing showing an image 48 of the three-dimensional shape model of the denture base of the new full denture.

FIG. 13A is a drawing showing a state in which a denture base is fabricated.

FIG. 13B is a drawing showing a state in which the denture base is fabricated.

FIG. 14A is a drawing showing a state in which the artificial teeth are mounted in the denture base.

FIG. 14B is a drawing showing a state in which the artificial teeth are mounted in the denture base.

FIG. 15 is a graph showing results of evaluation of anti-fouling performances of respective test pieces.

### BEST MODE FOR CARRYING OUT THE INVENTION

An example of an embodiment of the present invention is described in detail hereinafter with reference to the drawings.

<Structure of Removable Denture>

### (Schematic Structure of Full Dentures)

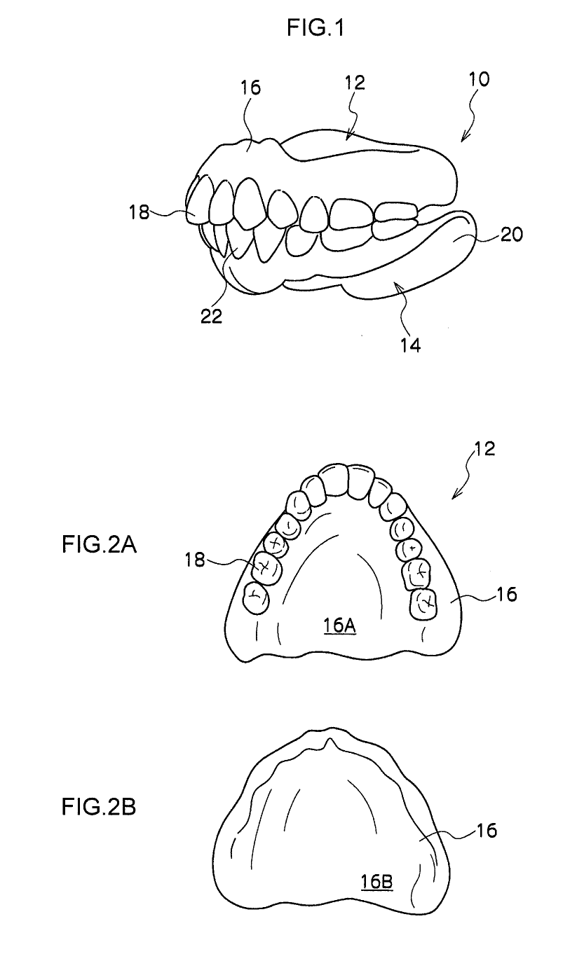

FIG. 1 is a perspective view showing the exterior of full dentures. FIG. 2A is a plan view viewing an upper jaw denture from the occlusal surface, and FIG. 2B is a plan view viewing the upper jaw denture from the mucosal surface. As shown in FIG. 1, full dentures 10, that are used in a patient having upper and lower toothless jaws, are structured such that an upper jaw denture 12 and a lower jaw denture 14 occlude one another. The upper jaw denture 12 has a denture base 16, and plural artificial teeth 18 that are implanted in the occlusal surface of the denture base 16. The lower jaw denture 14 has a denture base 20, and plural artificial teeth 22 that are implanted in the occlusal surface of the denture base 20.

As shown in FIG. 2A and FIG. 2B, the plan view of the upper jaw denture 12 is a substantially triangular shape whose lips side is the vertex and whose throat side is the base. At the denture base 16, the side that causes the artificial teeth to occlude is an occlusal surface 16A, and the side that is fit tightly to the oral mucosa is a mucosal surface 16B. At the occlusal surface 16A of the denture base 16, the outer peripheral portion, that runs along the two sides other than the base, protrudes in a convex shape, and the periphery of the base and the central portion are recessed.

The plural artificial teeth 18 are implanted in the portion that projects in a convex shape of the denture base 16. Similarly to natural teeth, the plural artificial teeth 18 are arrayed substantially symmetrically to the left and the right from the lips side toward the throat side. At the mucosal surface 16B of the denture base 16, oppositely of the occlusal surface 16A, the outer peripheral portion, that runs along the two sides other than the base, are recessed in a concave shape, and the periphery of the base and the central portion protrude.

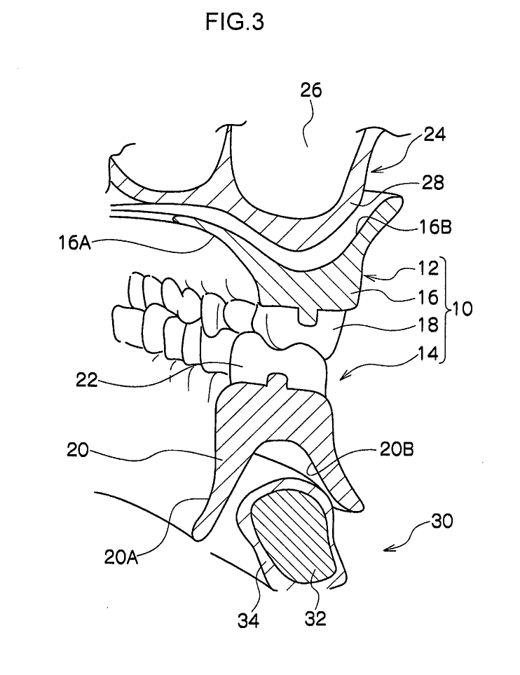

Although not illustrated, the plan view of the lower jaw denture 14 also is substantially triangular. At the denture base 20 of the lower jaw denture 14, the side that causes the artificial teeth to occlude is an occlusal surface 20A, and the side that is fit tightly to the oral mucosa is a mucosal surface 20B (see FIG. 3). Because the structure is approximately similar to the upper jaw denture 12, description thereof is omitted hereinafter.

(Fit-In State of Full Denture)

FIG. 3 is a partial sectional view showing a fit-in state of the full dentures. The full dentures 10 that are formed from the upper jaw denture 12 and the lower jaw denture 14 are fit-in between a jaw ridge 24 of the upper jaw and a jaw ridge 30 of the lower jaw within the oral cavity of a patient. The jaw ridge 24 of the upper jaw is structured by an upper jawbone 26 and gums 28 that cover the upper jaw bone 26. The mucosal surface 16B of the denture base 16 of the upper jaw denture 12 is fit-in so as to fit tightly with the gums 28 that are oral mucosa. Similarly, the jaw ridge 30 of the lower jaw is structured by a lower jawbone 32 and gums 34 that cover the lower jawbone 32. The mucosal surface 20B of the denture base 20 of the lower jaw denture 14 is fit-in so as to fit tightly with the gums 34 that are oral mucosa. Note that the jaw ridge is also called the teeth socket ridge.

In FIG. 3, for easy viewing, the mucosal surface 16B and the gums 28, and the mucosal surface 20B and the gums 34, are illustrated so as to be set apart, but are actually fit-in so that the both tightly fit together. After the loss of natural teeth, absorption of the jawbones advances, and the jaw ridges 24 and 30 recede. Therefore, when a long time period passes after the full dentures 10 are fabricated, there are cases in which the tight fit between the dentures and the oral mucosa is impaired, and inconveniences with the fit, such as pain due to the dentures or poor occlusion or the like, arise. In such cases, in order to overcome the problems of the old dentures, the need arises to correct the forms of the artificial teeth arrays and the mucosal surfaces of the old dentures and to fabricate new full dentures.

(Material and Machining Method of Denture Base)

The denture base 16 and the denture base 20 are resin bases that are formed by cutting a molded object of an ultrahigh molecular weight polyethylene. Ultrahigh molecular weight polyethylenes are generally classified as thermoplastic resins, and mean high-density polyethylenes whose weight average molecular weight is extremely high at around 1,000,000 to around 8,000,000. Ultra High Molecular Weight Polyethylene is abbreviated, and is called UHPE, UHMWPE or PE-UHMW. Hereinafter, it is abbreviated as “PE-UHMW”. PE-UHMW is produced by polymerizing ethylene by a low pressure polymerization method. By making the reaction time be long, an ultrahigh molecular weight can be obtained. With a thermoplastic resin, the higher the molecular weight is made to be, the lower the fluidity. In accordance with Japanese Industrial Standards (JIS-K-6936-1), the PE-UHMW that applies this standard is defined as a polyethylene material whose melt mass-flow rate (MFR), that is a measure expressing the fluidity of a thermoplastic resin, is less than 0.1 g/10 min in measurement at 190° C. and 21.6 kg. “Ultrahigh-molecular weight polyethylene” in the present invention means PE-UHMW to which the aforementioned Japanese Industrial Standard is applied.

Due to the highness of the molecular weight thereof, PE-UHMW has various characteristics such as, for example, the water absorption rate is low, the dimensional stability is excellent, the impact resistance in a broad temperature region is excellent, the wear resistance is excellent, it is self-lubricating, the chemical resistance is excellent, the specific gravity is light, the weathering resistance is excellent, the biocompatibility is excellent, and the like. Because of these characteristics, PE-UHMW is also used as a medical material such as a material for artificial joints or artificial limbs or the like. In applications as a medical material, PE-UHMW having a weight average molecular weight of greater than or equal to 5,000,000 is used.

Molded objects of PE-UHMW are supplied to the market in the form of a plate shape (a plate), a thick plate shape (a block), a thin plate shape (a sheet), a round pole shape (a rod) and the like. The fluidity of PE-UHMW at the time of melting is extremely low, and is not suited to injection molding. Therefore, a molded object of PE-UHMW is produced by compression molding or blow molding a powder of PE-UHMW. Note that powders of PE-UHMW that are on the market are particulates of an average particle diameter of 25 μm to 30 μm, and are produced by a suspension polymerization method.

PE-UHMW to which the aforementioned Japanese Industrial Standard is applied can be used as the resin for a base that is used for the denture base 16 and the denture base 20. PE-UHMW that has excellent biocompatibility is suitable as a resin for the base of a removable denture that is fit within the oral cavity. From actual results of being used in applications for medical materials, PE-UHMW of a weight average molecular weight of greater than or equal to 5,000,000 is more suitable. The denture base 16 and the denture base 20 are formed by cutting a molded object that is a block or a rod or the like of these PE-UHMW. For example, the product “THYLLENE” manufactured by Quadrant EPP Japan, or the like, can be used as the molded object of PE-UHMW.

In general, a resin base, that is formed of PMMA and is molded by injection molding using a plaster mold, shrinks after molding, and therefore, fabricating as per the mold is difficult. In contrast, because a resin base that is formed of PE-UHMW is fabricated by cutting a molded object, there is no shrinkage, and the resin base can be fabricated accurately. Further, even with a resin base formed of PMMA, in accordance with the production processes according to the present embodiment, the resin base can be fabricated accurately. The cutting of the molded object can be carried out by operating an NC machine tool on the basis of control information (NC data) that is created by CAD/CAM that is described hereafter.

(Comparison of Physical Property Values of Denture Base Materials)

Here, poly(methyl methacrylate) (PMMA), that is a widely-used resin for a base, and ultrahigh molecular weight polyethylene (PE-UHMW), that is the resin for a base of the present invention, are compared with regard to various items that are viewed as important for resins for bases. The results are shown in following Table 1. Note that a PE-UHMW for medical treatments having a weight average molecular weight of greater than or equal to 5,000,000 is used as the PE-UHMW.

TABLE 1

| | | | test |
|---|---|---|---|
| | PMMA | PE-UHMW | method |
| item | (conventional) | (present invention) | (ASTM) |
| specific gravity (g/cc) | 1.2 | 0.94 | D792 |
| hardness (Rockwell | 100 | 40 | D2240 |
| M scale) | | | |
| tensile strength (mPa) | 70-80 | 40-50 | D638 |
| rate of elongation(%) | 4-6 | 350-400 | D638 |
| bending strength | 70-120 | 20-90 | D790 |
| (mPa) | | | |
| bending modulus of | 2900-3200 | 880 | D790 |
| elasticity (mPa) | | | |
| impact strength (Izod | 20-30 | does not break | D256 |
| notched) | | | |
| water absorption rate | 0.3-0.35 | 0.01 | D570 |
| (wt %) | | | |
| thermal deformation | 100 | 70-80 | D648 |
| temperature (° C.) | | | |
| coefficient of thermal | 0.00007 | 0.0002 | D696 |
| expansion | | | |
| (cm/cm·° C.) | | | |
| weak acid resistance | X | X | |
| strong acid resistance | Z | X | |
| weak alkali resistance | Y | X | |
| strong alkali | Y | X | |
| resistance | | | |
| organic solvent | Z | X | |
| resistance | | | |

The above physical values are mainly values obtained by testing based on American Society for Testing and Materials standards (ASTM). Further, in items such as weak acid resistance and the like, “X” expresses, at around 20° C., 50° C. and 80° C., hardly any erosion, and “Y” expresses dissolving at a high concentration, and “Z” expresses dissolving.

The following can be understood from Table 1. As compared with PMMA, PE-UHMW has an extremely low “water absorption rate”, and a molded object (resin base) thereof has high surface tension, and it is difficult for fouling substances to adhere thereto, and it is also difficult for bacteria to arise. Further, as compared with PMMA, PE-UHMW has extremely high “impact strength” and “bending strength”, and it is difficult for a molded object (resin base) thereof to break. Further, as compared with PMMA, PE-UHMW has a light “specific gravity”, and lightening of the weight of a molded product (resin base) thereof is devised. Moreover, as compared with PMMA, PE-UHMW has excellent “chemical resistances (strong alkali resistance and the like)”, and a molded object (resin base) thereof has excellent durability with respect to cleaners.

In particular, a resin base made of PE-UHMW exhibits the excellent effect that, due to the characteristic that the “water absorption rate” of PE-UHMW is extremely small, as compared with other resin bases, it is difficult for fouling substances to adhere, and, even if fouling substances due adhere, the fouling substances can be removed easily. This anti-fouling performance is the most important performance of removable dentures from the standpoints of aesthetics, durability, oral hygiene, and the like. Further, due to the characteristic that the “impact strength” and “bending strength” of PE-UHMW are extremely high, it is difficult for a resin base made of PE-UHMW to break as compared with other resin bases. As seen above, a resin base made of PE-UHMW has an excellent anti-fouling performance and is difficult to break, and therefore, in accordance with the present invention, there can be provided a removable denture whose durability is extremely excellent as compared with conventional structures.

From the standpoint of aesthetics, the denture base 16 and the denture base 20 are usually colored to a hue that is near to the gums. A color material (pigment, dye, dyestuff) having excellent biocompatibility is used in coloring the resin base, in the same way as PE-UHMW. The coloring of the resin base may be carried out at the time of fabricating the molded object of PE-UHMW, or may be carried out after the cutting of the molded object of PE-UHMW.

When coloring at the time of fabricating the molded object, a color material is added to powder of PE-UHMW, and compression molding or blow molding is carried out. The added amount of the color material is less than or equal to around 1 wt % with respect to the entire molding material, and there are hardly any effects on other physical properties. When coloring after cutting of the molded object, surface modification of the PE-UHMW is carried out, and a color material in liquid form is impregnated from the surface layer to the interior.

(Types and Array of Artificial Teeth)

The artificial teeth 18 and the artificial teeth 22 are implanted in the convex portions of the occlusal surfaces of the resin bases made of PE-UHMW. Artificial teeth include resin teeth, porcelain teeth, and metal teeth. Because resin bases formed from acrylic resins such as PMMA and the like were widely used conventionally, resin teeth formed from acrylic resins such as PMMA and the like are used in full dentures due to good adhesiveness with the resin base and appropriate hardness. Resin teeth formed from PMMA are produced by a high pressure polymerization method, and the hardness is higher and the water absorption rate is lower than the resin base made of PMMA.

The artificial teeth 18 and the artificial teeth 22 are classified into those for premolar teeth and those for molar teeth. Further, when fabricating a denture, artificial teeth of various sizes, hues, forms (e.g., a circular form, a quadrangular form, an egg form) are on the market so as to be able to be selected in accordance with the preferences and the like of the patient. At the premolar teeth, arraying of the artificial teeth is carried out mainly in consideration of aesthetics and pronunciation functions (e.g., pronunciation of words beginning with the letter s). At the molar teeth, arraying of the artificial teeth is carried out mainly in consideration of stability of the denture and the chewing functions.

Further, the artificial teeth 18 and the artificial teeth 22 may be resin teeth formed of PE-UHMW. In the same way as a resin base formed of PE-UHMW, resin teeth formed of PE-UHMW have a low water absorption rate and excellent anti-fouling performance. Adhesion between resin teeth and a resin base that are formed from the same material is easy. Alternately, artificial teeth formed from PE-UHMW can be formed integrally with the denture base by cutting a molded object of PE-UHMW. By forming the artificial teeth and the denture base integrally, adhesion itself between the artificial teeth and the denture base is unnecessary, and the durability as a removable denture further improves. Note that, in this case, after cutting the molded object, the denture base 16 and the denture base 20 are colored to a hue that is near to the gums, and the artificial teeth 18 and the artificial teeth 22 are colored to a hue that is near to natural teeth.

(Method of Adhering Artificial Teeth and Denture Base Together)

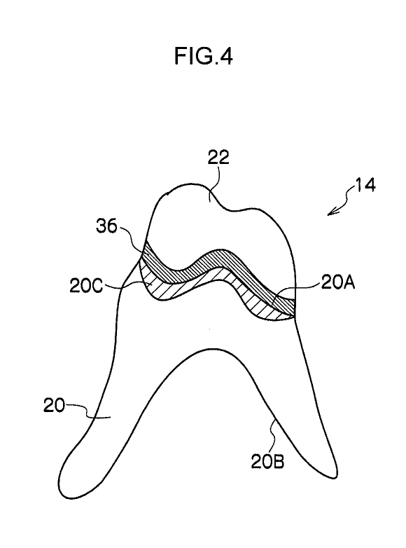

FIG. 4 is a sectional view showing a state in which an artificial tooth is adhered to a denture base. To explain by using the lower jaw denture 14 as an example, the surface of the occlusal surface 20A of the denture base 20 is modified, and a surface-modified portion 20C is formed in a vicinity of the occlusal surface 20A. The artificial tooth 22 is adhered to the surface-modified portion 20C of the artificial tooth 20 via an adhesive 36. An adhesive resin cement for dentistry such as 4-META/MMA-TBB resin, or the like, can be used as the adhesive 36.

4-META/MMA-TBB resin is a polymerizable adhesive in which an MMA monomer is polymerized by adding a catalyst, that includes tri-n-butylborane (TBB) as a polymerization initiator, to methyl methacrylate (MMA) in which 4-methacryloxyethyl trimellitate anhydride (4-META) is dissolved, and mixing it together with poly(methyl methacrylate) (PMMA). For example, “SUPER-BOND” from Sunmedical Co., Ltd. is known.

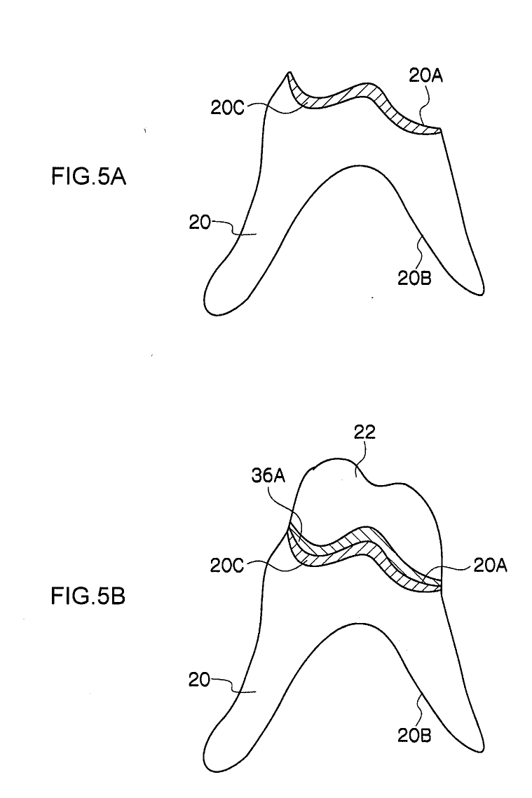

The method of adhering the artificial tooth and the denture base together is described in detail next. FIG. 5A and FIG. 5B are process diagrams explaining the process of adhering the artificial tooth and the denture base. First, as shown in FIG. 5A, the surface of the occlusal surface 20A of the denture base 20 is modified, and the surface-modified portion 20C is formed in a vicinity of the occlusal surface 20A. Surface modification of the denture base 20 is carried out because the surface of the PE-UHMW that structures the denture base 20 is hydrophobic (nonpolar) and the adhesiveness thereof with the PMMA that structures the artificial tooth 22 is low.

Next, as shown in FIG. 5B, an adhesive 36A is applied to the surface of the surface-modified portion 20C of the denture base 20. The artificial tooth 22 is positioned and disposed on the denture base 20, the artificial tooth 22 is made to fit tightly to the surface-modified portion 20C by the adhesive 36A, and the artificial tooth 22 is fixed on the denture base 20. The adhered structure shown in FIG. 4 is thereby completed. With regard to the upper jaw denture 12 as well, the artificial teeth 18 made of PMMA can similarly be fixed onto the denture base 16 made of PE-UHMW.

Here, the surface modification method of the PE-UHMW (molded object), that is applied to the surface modification of the denture base 16 and the denture base 20, is described. The surface modification of the PE-UHMW is carried out by three processes that are (1) an impregnating process that impregnates an impregnant, (2) an activation process that introduces a hydrophilic base, and (3) a process that grafts a monomer. Each of the processes (1) through (3) is described hereinafter.

(1) Impregnating Process

Impregnating process is a process that causes a compound, that has affinity with respect to PE-UHMW, to contact the surface of PE-UHMW at a temperature that is less than or equal to the softening point of PE-UHMW, and impregnates that compound from the surface of the PE-UHMW. The compound that is impregnated is called the impregnant. The impregnant may be used in the form of a solution or a dispersion liquid. Organic solvents such as toluene, xylene, a-chloronaphthalene, dicyclobenzene, decahydronaphthalene, and the like can be used as the impregnant with respect to PE-UHMW. Further, a solution in which ortho-hydroxybiphenyl (a solid at room temperature) is dissolved in an organic solvent such as methanol or the like can be used as the impregnant.

This impregnating process is a process in which the impregnant seeps into an amorphous region of the PE-UHMW and forms gaps within the molded object. The surface of the PE-UHMW is substantially not modified. For example, even when an organic solvent is used as the impregnant, PE-UHMW does not dissolve in the organic solvent. The impregnating process has the effect of facilitating the activating process and the grafting process and the like that are carried out next.

Next, preferable ranges of the impregnated amount of the impregnant with respect to PE-UHMW are expressed as weight increase rates. When the thickness of the PE-UHMW is less than 100 μm, the preferable impregnated amount is 0.1 to 40 wt %. When the thickness of the PE-UHMW is greater than or equal to 100 μm, the preferable impregnated amount is 0.1 to 40 wt % for the portion that is within a depth of 100 μm from the surface of the PE-UHMW. In the case of a PE-UHMW whose thickness or diameter is less than or equal to around 20 mm, for convenience, it is preferable to make the impregnated amount be around 0.1 to 10 wt %.

The conditions such as the time, the temperature and the like of the impregnating process are appropriately selected in accordance with the shape and the like of the object of processing, such that the impregnated amount of the impregnant is within the aforementioned suitable ranges. For example, in the case of a molded product of PE-UHMW such as a test piece or the like, after impregnating for around 5 minutes to 30 minutes with an impregnant of room temperature to 70° C., the molded product of PE-UHMW is set in a centrifugal dryer and the impregnant is scattered, and the impregnating process is ended when there has become a state in which the impregnant is removed to a certain extent and the surface is apparently dry. After the liquid removal by the centrifugal dryer, the molded product of PE-UHMW may be dried by using a dryer. The remaining impregnant is removed by washing that is carried out after the activating process and the grafting process that follow.

(2) Activating Process

The activating process is a process for introducing hydrophilic groups such as carbonyl groups or the like into the surface of the PE-UHMW. The hydrophilic groups are not limited to carbonyl groups. Other than carbonyl groups, functional groups containing oxygen or nitrogen or the like, such as hydroxyl groups, carboxyl groups, amino groups, or the like, or unsaturated bonds or the like, may be introduced. Various types of processes such as plasma process, ozone process, ultraviolet ray irradiation, corona discharging, high-pressure discharging, and the like can be given as examples of suitable methods of the activating process. When the entire surface is subjected to activating process, ozone process, that does not involve the irradiation of electromagnetic waves, is suitable.

The extent of the activating is adjusted appropriately so as to not impair the strength of the PE-UHMW. In carrying out surface modification of the PE-UHMW, it is sufficient that the PE-UHMW be processed to the extent that the introduction of the hydrophilic groups such as carbonyl groups or the like can be confirmed. For example, carbonyl groups have absorption that is based on the C═O bond, in a vicinity of 1710 cm⁻¹ of the infrared absorption spectrum (IR). Accordingly, when carbonyl groups are introduced, a degree of absorption in the vicinity of 1710 cm⁻¹ of the surface of the PE-UHMW is observed by IR. At the point in time when the degree of absorption in a vicinity of 1710 cm⁻¹ increases 1% to 2% as compared with the degree of absorption before processing, the introduction of carbonyl groups is confirmed, and it suffices to end the activating process.

(3) Grafting

Grafting is a process that graft-polymerizes a hydrophilic monomer at the surface of the PE-UHMW that has been subjected to prior processings (the impregnating and the activating). Acrylic acid or methacrylic acid can be used as the hydrophilic monomer. A solution containing the monomer and a polymerization initiator, or monomer vapor, is filled into a reaction vessel. Water-soluble polymerization initiators such as ceric ammonium nitrate, potassium persulfate, and the like are suitably used as the polymerization initiator.

In the case of thermal grafting polymerization, PE-UHMW is placed into this reaction vessel, the vessel interior is heated to the reaction temperature, and graft polymerization is carried out. In the case of photografting polymerization, PE-UHMW is placed into this reaction vessel, ultraviolet rays are illuminated onto the surface of the PE-UHMW, and photografting polymerization is carried out. Alternately, in accordance with the surface shape of the PE-UHMW that has been cut, a solution containing a monomer and the like is coated on the portion for which surface modification is desired, and graft polymerization is carried out by heating or illumination of ultraviolet rays.

Note that, after the grafting ends, the PE-UHMW is washed in a washing device, and the remaining impregnant, unreacted monomer, solvent and the like are removed. A solvent, that dissolves the impregnant, the monomer and the solvent and does not dissolve the PE-UHMW, is used in the washing. Washing methods such as washing in running liquid, immersion washing, spray washing, or the like can be suitably used as the washing method. As needed, thermal washing or ultrasonic wave washing may be carried out. After washing, the PE-UHMW is set in a centrifugal dryer and the liquid component is removed, and the PE-UHMW is dried to a predetermined extent by using a dryer.

<Method of Producing Removable Denture>

An embodiment of a method of producing the above-described removable denture relating to the present invention is described next.

(Conventional Fabrication Method)

Here, the basic flow of conventional full denture treatment is described briefly.

(1) When a patient comes to a clinic bringing in their old dentures that no longer fit, the dentist inquires as to the patient's symptoms, carries out an examination of the oral cavity, an X-ray examination, an examination of functions, and the like, and diagnoses the problematic points of the old dentures. (2) Next, snap impressions of the upper and lower jaws of the patient are taken, and, from the snap impressions, individual trays that suit the patient are fabricated. (3) Next, precise impressions are taken by using the individual trays.

(4) Next, on the basis of the precise impressions that are taken, individual upper and lower plaster models that suit the individual patient are fabricated. Occlusion bases for reproducing the bite of the upper and lower jaws are fabricated on these plaster models. (5) Next, the oral cavity interior of the patient is examined and the inter-jaw relationship between the upper and lower jaws is observed, and the inter-jaw relationship of the patient is reproduced at the occlusion bases. (6) Next, the oral cavity interior is examined together with the patient, and, while materials and hues are discussed with the patient, any among numerous, readied artificial teeth are selected.

(7) Next, the artificial teeth are arrayed on the occlusion bases that were fabricated in (5), and wax dentures are fabricated. (8) Next, the fabricated wax dentures are trial-fit in the patient, evaluation is carried out, and necessary corrections are carried out. (9) Next, by using the embedding-inlay method, the wax is replaced with the resins for the bases, and the full dentures are completed. (10) The completed full dentures are fit in the oral cavity, and a final evaluation is carried out.

As described above, conventional full denture treatment proceeds by the divided labor of numerous related persons, that are the inspection and diagnosis by the dentist, assisting work by a dental hygienist, and technical work by a dental technician or the like. Further, the patient must come to the clinic several times for the examination, the taking of impressions, the trial fitting, and the like. Therefore, conventionally, an extremely long time period was required until a full denture was completed.

(Fabrication Method Applying CAD/CAM Technology)

In the present embodiment, description is given of a method of fabricating the full dentures 10, that have the above-described structure, by applying CAD/CAM technology. Further, description is given of a case in which the new full dentures 10 that have denture bases made of PE-UHMW are fabricated from old full dentures that have denture bases made of PMMA. The new full dentures 10 correspond to the full dentures relating to the present invention. Structural portions of the new full dentures 10 that are the same as those of FIG. 1 through FIG. 5 are denoted by the same reference numerals, and description thereof is omitted. Hereinafter, description is given by dividing the production method relating to the present embodiment into seven processes.

(1) Correction of Old Dentures

First, examination of the dentures that the patient currently uses (the old dentures) is carried out. As a result of the examination, the old full dentures are corrected as needed. The correction of the old full dentures is carried out by correcting the forms of the mucosal surfaces of the upper and lower denture bases. Correction of the form of the mucosal surface of a denture base formed from PMMA (tissue conditioning) can be carried out by using a mucosa adjusting material called a tissue conditioner. By using the mucosa adjusting material, PMMA resin is added to the insufficient portions, and the PMMA resin of the excess portions is removed by grinding or the like. Due thereto, the occlusion height also is corrected. Note that the form of the mucosal surface and the occlusion height can also be corrected by base modification of the denture base, and not by using a mucosa adjusting material. Further, when a new denture is needed because the old denture has broken for example, it suffices to simply adhere the broken old denture, and therefore, the form of the mucosal surface and the occlusion height do not have to be corrected.

It is preferable to use a mucosa adjusting material that contains an X-ray non-transmitting substance, such as barium or the like, as the mucosa adjusting material. When correction is carried out by using a mucosa adjusting material that contains an X-ray non-transmitting substance, CT imaging data of the corrected old full dentures can be acquired accurately in the CT imaging that is the next process. Note that an example of fabricating the “upper jaw denture 12” is described hereinafter, but the “lower jaw denture 14” can be fabricated by using a similar method.

(2) CT Imaging of Old Denture

Next, the old full dentures, that have been corrected by using a mucosa adjusting material that contains an X-ray non-transmitting substance, are fixedly placed at an imaging position of an X-ray CT device and CT imaging is carried out, and CT imaging data of the corrected old full dentures is obtained. CT is an abbreviation for computed tomography. An X-ray CT device is structured by an imaging device that carries out CT imaging by using X-rays, and a computer system that controls the respective sections of the imaging device, and forms, into an image, the distribution data of the X-ray absorption values or the like obtained by the CT imaging, and obtains CT imaging data.

The X-ray CT examination device “FINECUBE” manufactured by The Yoshida Dental Mfg. Co., Ltd. can be used as an X-ray CT device for dentistry. A head portion fixing device, that nips and fixes the head portion of the patient at the time of CT imaging, is provided at the X-ray CT device for dentistry. The head portion of the patient is fixed to the imaging device by this head portion fixing device. The imaging device has an X-ray irradiating section that irradiates an X-ray cone beam, and an X-ray detecting section that detects transmitted X-rays. The X-ray irradiating section and the X-ray detecting section are disposed so as to oppose one another with the fixed head portion of the patient located therebetween. Due to the imaging device revolving one time around the periphery of the head portion of the patient, CT imaging of the head portion is carried out. For example, the corrected old full dentures are fixedly disposed at the imaging position by the above-described head portion fixing device, and CT imaging can be carried out.

Hereinafter, the computer (system) is described as having a CPU, a ROM, a RAM, a memory such as a hard disk, a data input device such as a hard disk drive, an inputting device such as a mouse and a keyboard, and a display device such as a display.

Software for imaging processing that carries out image reconstruction processing is installed in recent X-ray CT devices, as in the “FINECUBE” X-ray CT examination device. Three-dimensional image data (volume data) and tomographic image data (slice data) can be obtained by image reconstruction processing of CT imaging data. Further, the obtained image data can be stored in Digital Imaging and COmmunication in Medicine (DICOM) format. DICOM is a reference standard for medical imaging and communications.

Further, the image data in DICOM format can be displayed by using DICOM Viewer that is software for browsing. Namely, by using a computer in which DICOM Viewer is installed and that has interchangeability due to standardization in the image format, images of various forms such as CT captured images, three-dimensional images, tomographic images can be displayed on a display device such as a display (hereinafter called “display”) that is connected to the computer. Various diagnoses can be carried out from these displayed images.

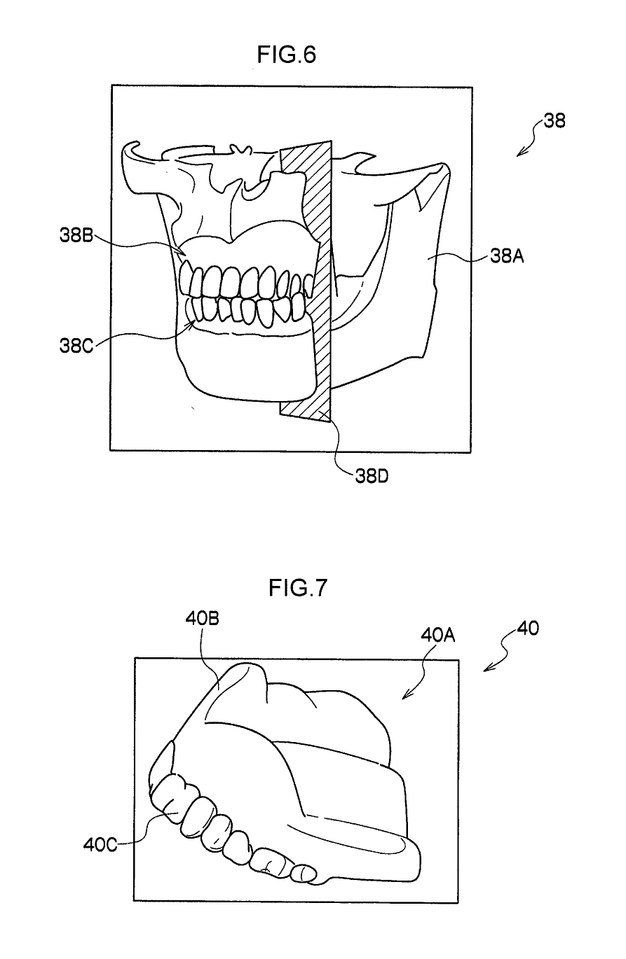

FIG. 6 is a three-dimensional image obtained from CT imaging data of the time of CT imaging the head portion of a patient in whom full dentures are fit. An X-ray CT device for dentistry is used in order to acquire such a three-dimensional image. An image 38, that expresses the three-dimensional shape of a skeleton 38A, an upper jaw denture 38B and a lower jaw denture 38C of the patient, is displayed on the display. Further, a tomographic image of the time of cutting at cross-section 38D can also be displayed by designating the spatial position coordinate of the cross-section 38D.

FIG. 7 is a three-dimensional image of an upper jaw denture that is obtained from CT imaging data at the time of carrying out CT imaging with the corrected upper jaw denture fixedly disposed at the imaging position. As shown in FIG. 7, an image 40, that expresses the three-dimensional shape of an upper jaw denture 40A, is displayed on the display. By carrying out CT imaging with the corrected old full dentures being fixedly placed at the imaging position and not being fit in the patient, and directly obtaining CT imaging data of the corrected old full dentures, the labor of image processing, such as deleting the skeleton and unnecessary portions from the three-dimensional image shown in FIG. 6, can be eliminated. Further, the imaging is completed without X-rays being irradiated onto the patient.

Note that a three-dimensional image is not only obtained from CT imaging data of the time of CT imaging, and can also be obtained by magnetic resonance imaging (MRI). Because MRI captures images by utilizing magnetism, it is superior with respect to the point that there is no harm to the human body at all, as compared with X-rays. Therefore, if the corrected old full dentures are fit in the patient and MRI imaging is carried out, MRI imaging data can be acquired with the old full dentures fit as is in the patient.

Further, by designating the angle of rotation at the spatial position coordinate, images seen from different angles can be displayed. In FIG. 7, by making the upper jaw denture 40A be an image that is seen by looking down from above without displaying the skeleton and unnecessary portions, the form of the mucosal surface of a denture base 40B is easy to see, and the array of the molar teeth portions of artificial teeth 40C is easy to see.

(3) CT Imaging of Artificial Teeth

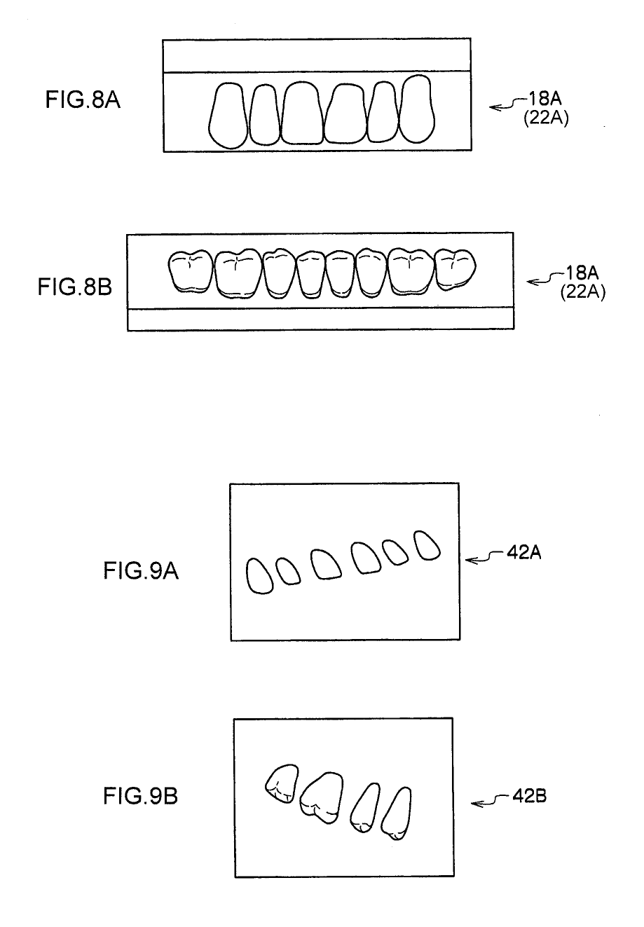

Next, the planned artificial teeth 18 and artificial teeth 22 that are to be used in the new full dentures 10 are fixedly placed at the imaging position of the X-ray CT device and CT imaging is carried out, and the CT imaging data of only the artificial teeth is obtained. FIG. 8 is photograph images (two-dimensional images) of the artificial teeth. The artificial teeth 18 and the artificial teeth 22 are resin teeth that are formed from PMMA acrylic resin. The artificial teeth 18 and the artificial teeth 22 are on the market separately for premolar teeth and for molar teeth. FIG. 8A is a photograph image of artificial teeth for premolar teeth, and FIG. 8B is a photograph image of artificial teeth for molar teeth. Note that, if there is already data that can display a three-dimensional image of the artificial teeth, there is no need to obtain the imaging data.

As described above, three-dimensional image data and tomographic image data can be obtained from the image reconstruction processing of the CT imaging data. Further, the obtained imaging data can be stored in DICOM format. Further, images of various forms, such as CT captured images, three-dimensional images, tomographic images, and the like can be displayed on the display by using DICOM Viewer.

FIG. 9A and FIG. 9B are three-dimensional images obtained from CT imaging data of the time of CT imaging artificial teeth. As shown in FIG. 9A, an image 42A that shows the three-dimensional shapes of artificial teeth for premolar teeth is displayed on the display. Further, as shown in FIG. 9B, an image 42B that shows the three-dimensional shapes of artificial teeth for molar teeth is displayed on the display.

(4) Fabrication of Master Data of New Dentures by CAD

Next, a three-dimensional shape model of the new full dentures 10 is designed by using three-dimensional CAD software, and by using the CT imaging data of the corrected old full dentures and the artificial teeth as measurement data. Shape data (master data) of the obtained three-dimensional shape model of the new full dentures 10 is obtained.

CAD is an abbreviation for Computer Aided Design. “CATIA” manufactured by Dassault Systemes, or the like, can be used as the three-dimensional CAD software. “CATIA” is widely-used three-dimensional CAD software. Due to the recent popularization of implant technology, CAD/CAM systems have been widely introduced in the field of dental techniques as well. Therefore, three-dimensional CAD software exclusively for dental techniques also is being developed. These three-dimensional CAD software exclusively for dental techniques can also be used.

In an example using conventional CAD/CAM technology, the three-dimensional shapes of the plaster models obtained in process (4) of the conventional fabrication method were measured by a contact-method or a non-contact method, and optical impressions were obtained. As measurement by a non-contact method, there are a method of carrying out measurement by using laser light and acquiring an optical impression, and a method of acquiring an optical impression from plural images captured by a CCD camera. In contrast, in the present embodiment, the measurement data of the three-dimensional shape is obtained from the CT imaging data of the corrected old full dentures and the artificial teeth, and not measurement data of plaster models. In accordance with CT imaging, measurement of a three-dimensional shape can be completed in a short time.

First, the three-dimensional CAD software is started-up on a computer, and the CT imaging data of the corrected old full dentures and the CT imaging data of the artificial teeth are taken-in, and are converted into three-dimensional image data for CAD. A virtual space (three-dimensional image) created by the computer is displayed on the screen of a display connected to the computer. In this virtual space, the measurement data of the three-dimensional shape of the old full dentures is corrected, and a three-dimensional shape model of the new full dentures 10 is designed.

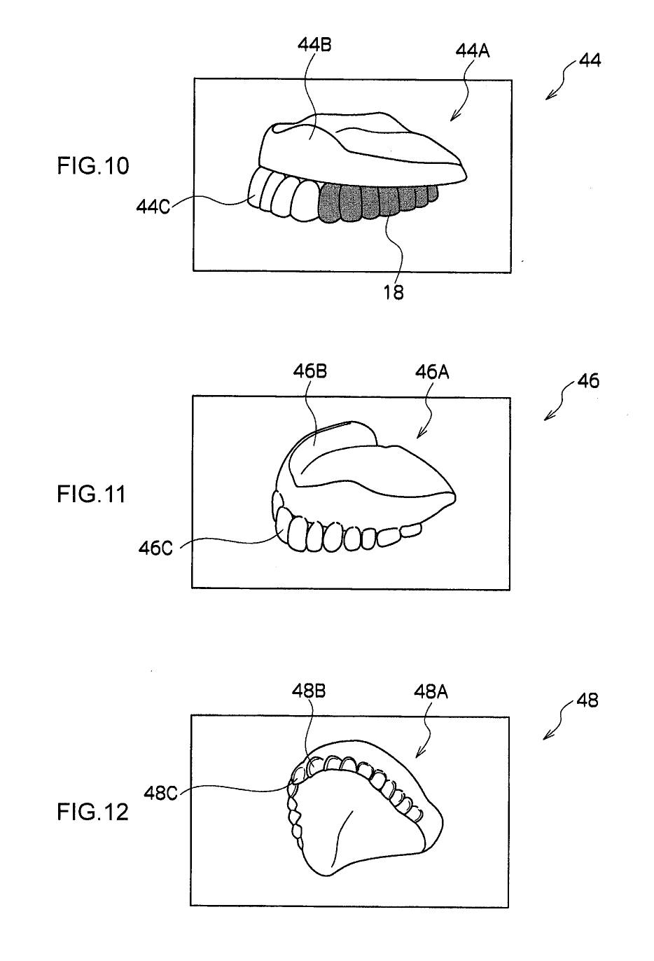

FIG. 10 is a drawing showing a state of designing the three-dimensional shape model of new full dentures. As shown in FIG. 10, an image 44 showing the three-dimensional shape of corrected old full dentures 44A is displayed on the display on the basis of three-dimensional image data for CAD. In the virtual space, artificial teeth 44C for which re-arraying is needed are taken-out from the three-dimensional shape of the old full dentures 44A. By using images (the colored portions in the drawing) showing the three-dimensional shapes of the artificial teeth 18, arraying of the artificial teeth is carried out with respect to a denture base 44B displayed in the virtual space. Namely, in the virtual space, while, by referring to the CT imaging data, carrying out simulation such that the height of the occlusion plane and the occlusion relationship become an appropriate state, the new artificial teeth 18 are re-arrayed at the denture base 44B instead of the artificial teeth 44C of the old full dentures.

FIG. 11 is a drawing showing an image 46 of a three-dimensional shape model of the new full dentures. A three-dimensional shape model 46A of the new full dentures 10 is completed in the virtual space by the above-described processes. The three-dimensional shape model 46A of the new full dentures 10 is structured by a three-dimensional shape model 46B of the denture base, and a three-dimensional shape model 46C of the artificial teeth. The shape data of the three-dimensional shape model 46A of the new full dentures 10 is stored in the memory as master data.

(5) Creation of Denture Base Data of New Denture by CAD

Next, shape data of the denture base is acquired from the three-dimensional shape model of the new full dentures 10 by using three-dimensional CAD software. FIG. 12 is a drawing showing an image 48 of a three-dimensional shape model of the denture base of the new full dentures. By using three-dimensional CAD software, the artificial teeth are removed from the three-dimensional shape model of the new full dentures 10, and a three-dimensional shape model 48A of the denture base is designed. In the three-dimensional shape model 48A of the denture base, the artificial teeth that were arrayed at an occlusal surface 48B side are removed, and plural recesses 48C are formed in the traces where the artificial teeth were removed. The shape data of this three-dimensional shape model 48A of the denture base is stored in the memory in association with the master data.

(6) Cutting of Denture Base of New Denture by CAM

Next, by using three-dimensional CAM software, computation of the path along which a cutting tool moves (the tool path) is carried out from the shape data of the three-dimensional shape model 48A of the denture base, and the computed values are converted into control information (NC data) for controlling an NC machine tool. CAM is an abbreviation for Computer Aided Manufacturing. “MASTERCAM” manufactured by CNC Software, Inc., or the like, can be used as the three-dimensional CAM software. Then, the NC data that is generated by the three-dimensional CAM software is transmitted to a machining center.

The machining center is an equipment that is made into computerized numerical control and that automatically machines a manufactured product by using various cutting tools. The five-axis control machining center “VARIAXIS 200” manufactured by Yamazaki Mazak Corporation, or the like, can be used as the machining center. By using a five-axis control machining center, complex curved surfaces can be machined while the five axes of the machine tool (the X-axis, the Y-axis, the Z-axis, and the posture of the tool) are controlled simultaneously.

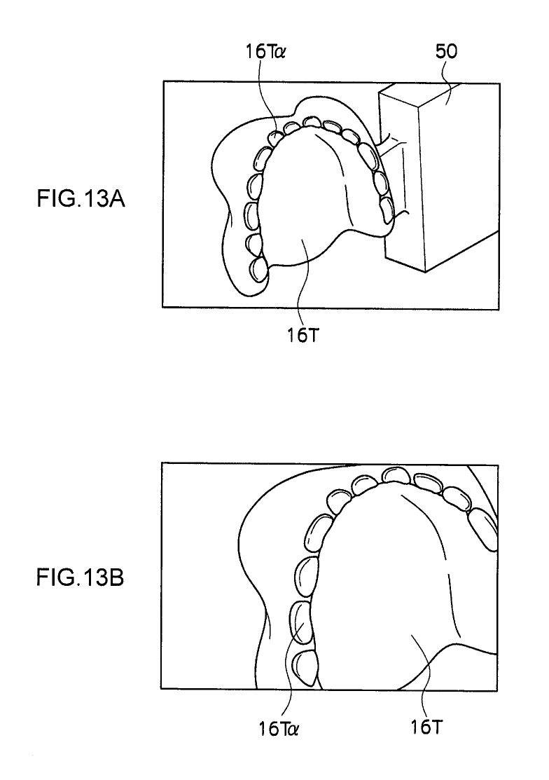

FIG. 13A and FIG. 13B are drawings showing a state in which a denture base is fabricated. FIG. 13B is a partial enlarged view of FIG. 13A. At the above-described machining center, on the basis of the NC data, a block 50 of ultrahigh molecular weight polyethylene (PE-UHMW) is cut, and a denture base 16T for an upper jaw denture, that is made of PE-UHMW, is fabricated. Namely, the denture base 16T is cut-out from the PE-UHMW block 50.

Note that the PE-UHMW block 50 is an uncolored resin block, and the denture base 16T that is uncolored is obtained from the PE-UHMW block 50. Further, plural recesses 16Tα for arraying the artificial teeth 18 are formed in the mucosal surface of the denture base 16T. Further, in FIG. 13, in order to easily see the state in which the denture base 16T is cut-out from the PE-UHMW block 50, the denture base 16T and the PE-UHMW block 50 are shown in a continuous shape, but, in actuality, the denture base 16T and the block 50 are separated at the stage when the cutting-out ends.

(7) Mounting of Artificial Teeth

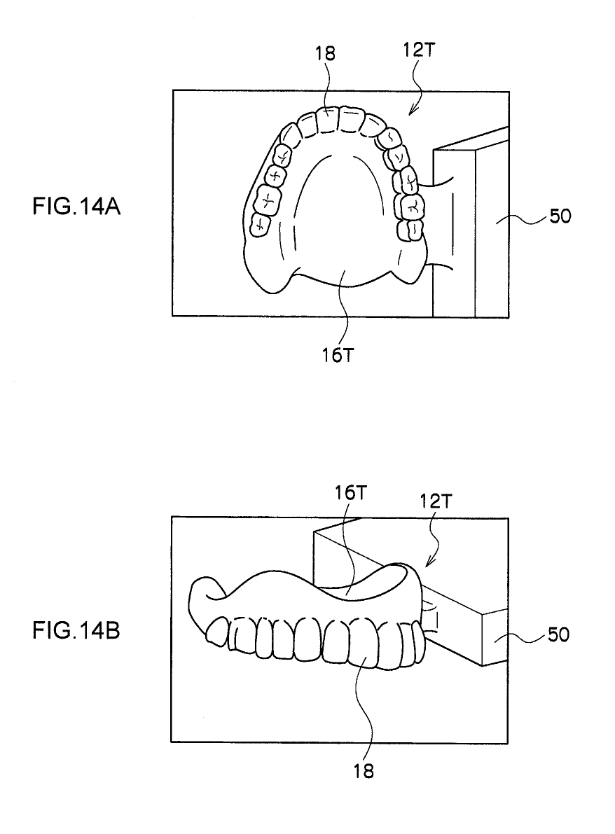

FIG. 14A and FIG. 14B are drawings showing a state in which artificial teeth are mounted to the denture base. FIG. 14B is a partial enlarged view of FIG. 14A. Lastly, the artificial teeth 18 are mounted to the uncolored denture base 16T. Due thereto, an upper jaw denture 12T, that has the uncolored denture base 16T, is obtained. The denture base 16T of the upper jaw denture 12T is colored to the color of the gums, and the upper jaw denture 12 that is a portion of the new full dentures 10 is completed.

First, the master data that is stored in the memory is read-out, and an image of the three-dimensional shape model of the new full dentures 10 is displayed on the display. While referring to the array of the artificial teeth of the displayed image, the artificial teeth 18 are temporarily placed at the uncolored denture base 16T. Each of the plural recesses 16Tα is formed so as to match the shape of the artificial tooth 18 to be disposed, and therefore, the compatibility can be confirmed by the temporary placing. The artificial teeth 18, that are formed of PMMA and are temporarily placed, are then removed once.

Next, the three processes that are the (1) impregnating process, the (2) activating process that introduces the hydrophilic groups, and the (3) grafting process of the monomer, are carried out as described above on the surface of the denture base 16T made of PE-UHMW, and surface modification of the PE-UHMW is carried out such that it can be adhered with the acrylic resin. In the present embodiment, because the denture base 16T is colored after being formed, surface modification is carried out on the entire surface of the denture base 16T that is made of PE-UHMW.

Here, an example of the respective processes of the surface modification is described in detail. The processing conditions of the respective processes that are described hereafter are examples, and the processing conditions of the respective processes can be appropriately optimized in accordance with the shape and the like of the denture base 16T that is made of PE-UHMW.

First, the denture base 16T made of PE-UHMW is immersed for 15 minutes in toluene that is heated to 70° C., and toluene (the impregnant) is impregnated in the surface of the denture base 16T. Next, after the denture base 16T is lightly rinsed with methanol, the excess impregnant on the surface is wiped-off by paper, and the denture base 16T is left for five minutes at room temperature and dried.

Next, the activation process is carried out on the surface of the denture base 16T by ozone process. The denture base 16T that has undergone the impregnating process is placed within a reaction vessel made of hard glass. Ozone that is generated by an ozone generator is introduced into the reaction vessel such that the ozone generating speed is around 1.0 (g/hour), and the ozone process is carried out on the denture base 16T for around two hours. After the ozone process ends, the denture base 16T is removed from the reaction vessel.

Next, grafting is carried out at the surface of the denture base 16T that was subjected to ozone process. A water-soluble in which 1.0 ml of acrylic acid and 20 mg of ceric ammonium nitrate were dissolved in 180 ml of water, is filled in a reaction vessel made of a hard glass. The denture base 16T that was subjected to the ozone processing is immersed in this aqueous solution. By using a high-pressure mercury lamp of 400 watts, ultraviolet rays are irradiated onto the surface of the denture base 16T from a distance of 20 cm. While maintaining the reaction temperature at 30° C., ultraviolet rays are irradiated for two hours, and photografting polymerization is carried out. After the grafting ends, the denture base 16T is removed from the reaction vessel.

Next, the denture base 16T that was grafted is immersed in a washing device (immersion vessel) filled with a detergent aqueous solution of 60° C. After carrying out immersion washing for 10 minutes at 60° C., washing in running water is further carried out, and the unreacted monomer and the like are removed. Further, the denture base 16T is placed in a centrifugal dryer and moisture is removed, and the denture base 16T is dried to a predetermined extent. Due thereto, the surface of the denture base 16T is made to be hydrophilic, and can adhere to acrylic resins. Further, the denture base 16T can be colored by impregnating a dye or dyestuff.

The adhesive resin cement for dentistry “SUPER-BOND”, that is manufactured by Sunmedical Co., Ltd. and is a polymerizable adhesive, is coated on the respective surfaces of the recesses 16Tα (see FIG. 13) that were surface-modified. The artificial teeth 18 are re-disposed as per the temporary placement, and are fit-tightly together to the respective recesses 16Tα that were surface-modified with the unhardened adhesive. “SUPER-BOND” is an adhesive for dentistry that can be used within the oral cavity, and, as described above, polymerizes when a polymer is added to a monomer to which is added a catalyst that contains a polymerization initiator. The adhesive is polymerized, and fixes the artificial teeth 18 on the denture base 16T.

Lastly, a color material is impregnated, from the surface layer to the interior, into the surface of the denture base 16T that has been surface-modified, and the denture base 16T is colored to the color of the gums. The upper jaw denture 12 of the new full dentures 10 is thereby completed. As described above, the lower jaw denture 14 of the new full dentures 10 can be fabricated by using a similar method. In general, iron oxide (red color) and titanium oxide (white color) are mixed-together in an appropriate proportion, and are used as the color material in the coloring of the resin base. Red-color color materials, white-color color materials that are on the market and are suited to PE-UHMW can be appropriately mixed-together and used as the color material that colors the denture base 16T. Further, as described above, color materials that have excellent biocompatibility are preferable as the color material.

Note that, in process (4), plural three-dimensional shape models 46A of the new full dentures 10 can be fabricated beforehand. In accordance with the plural three-dimensional shape models of the new full dentures 10, plural full dentures for test fitting can be fabricated by rapid prototyping or the like, and, after testing fitting on the patient, the three-dimensional shape model of the new full dentures 10 that are best suited can be selected, and, on the basis of the selected three-dimensional shape model, process (5) through process (7) can be carried out, and the new full dentures 10 having denture bases made of PE-UHMW can be fabricated.

Further, when the artificial teeth and the denture base are to be formed integrally of PE-UHMW by cutting a molded object of PE-UHMW, first, above-described processes (1) through (4) are executed. Next, process (5) is omitted, and, in process (6), computing of the tool path is carried out from the shape data (master data) of the three-dimensional shape model 46A of the new full dentures 10 obtained in process (4), and the computed values are converted into NC data. Then, the generated NC data is transmitted to the machining center. At the machining center, on the basis of the NC data, a block of transparent PE-UHMW is cut, and an upper jaw denture having artificial teeth and a denture base made of PE-UHMW is fabricated. Namely, an upper jaw denture that is formed integrally of transparent PE-UHMW is cut-out from the PE-UHMW block.

The mounting of the artificial teeth of process (7) is unnecessary. However, in order to carry out coloring of the upper jaw denture, in the same way as in process (7), surface modification is carried out on the entire surface of the PE-UHMW, and dye is impregnated from the surface layer to the interior into the surface-modified surface, and coloring of the upper jaw denture is thereby carried out. The denture base of the upper jaw denture is colored to a hue that is near to the gums, and the artificial teeth are colored to a hue that is near to natural teeth. The upper jaw denture of all PE-UHMW is thereby completed. A lower jaw denture of all PE-UHMW can be fabricated by using a similar method.

Further, when fabricating new full dentures that have denture bases made of PMMA, first, the above-described processes (1) through (5) are executed. Next, in process (6), a block of poly(methyl methacrylate) (PMMA) is cut, and the denture base is cut-out. Then, the artificial teeth are mounted in process (7), but there is no problem with adhesiveness if the denture base and the artificial teeth are both formed of PMMA, and therefore, the surface modification process of the denture base is omitted.

Note that, when a molded object of PMMA is cut and the artificial teeth and the denture base are formed integrally of PMMA, there are the same processes as a case in which a molded object of PE-UHMW is cut and the artificial teeth and the denture base are formed integrally of PE-UHMW. However, the denture base, or the integrally formed product of the artificial teeth and the denture base, can be formed also by layering of resin, optical molding or the like, and not by cutting of a resin molded object. Further, various types of thermoplastic resins and thermosetting resins can be used without being limited to PE-UHMW or PMMA, and, for example, ABS resin, polyacetal resin, fluorine resin, and the like can be used. In particular, if fluorine resin is used, an excellent anti-fouling performance is obtained.

(Comparison with Conventional Fabrication Method)

In the present embodiment, by fabricating the full dentures by applying CAD/CAM technology, as compared with conventional fabrication methods, the fabrication processes of the full dentures can be greatly simplified, and the full dentures can be fabricated in a short time. Further, as compared with conventional fabrication methods, the number of times that a patient should go to a clinic can be reduced, and the burden on both the dentist and the patient can be lessened.

Further, in the present embodiment, correcting of the old full dentures is carried out by carrying out form correction (tissue conditioning) of the mucosal surface of the denture base by using a mucosa adjusting material. By designing a three-dimensional shape model of the new full dentures by CAD on the basis of the measurement data of the three-dimensional shape of the corrected old full dentures, design errors due to CAD are reduced, and a denture base that is actually suited can be produced by applying CAD/CAM technology.

Further, in the present embodiment, at the time of designing the three-dimensional shape model of the new full dentures by CAD, measurement data of the three-dimensional shape is obtained from the CT imaging data of the corrected old full dentures and the artificial teeth, and not the measurement data of a plaster model by an optical measuring device or the like in accordance with laser irradiation. In accordance with CT imaging, measurement of the three-dimensional shape can be completed in a short time. Further, the measurement accuracy by CT imaging is high, and the fabrication accuracy of the denture base by CAD/CAM can be greatly improved.

Further, in the present embodiment, a block of ultrahigh molecular weight polyethylene (PE-UHMW) is cut by an NC machine tool, and a denture base for an upper jaw denture that is made of PE-UHMW is cut-out. Accordingly, there is no shrinkage at the time of molding, such as a conventional denture base that is made of PMMA and is molded by injection molding using a plaster mold, and the denture base can be fabricated accurately. In other words, the production method of the present embodiment that applies CAD/CAM technology is a method that is most suited to the production of a denture base, whether it is a denture base made of PE-UHMW or a denture base made of PMMA. In the method that applies CAD/CAM technology, when full PE-UHMW or full PMMA upper and lower jaw dentures are cut-out by cutting from a PE-UHMW block or a PMMA block, positional offset at the time of adhering the artificial teeth also does not arise, and the dentures overall can be fabricated even more accurately.

Note that while the above embodiment describes a method of fabricating full dentures by applying CAD/CAM technology, the anti-fouling performance of a removable denture can be improved by using ultrahigh molecular weight polyethylene (PE-UHMW) at the removable denture. Therefore, when using PE-UHMW as a material, the removable denture can also be produced by another production method that is conventionally known, provided that a removable denture having a denture base made of PE-UHMW can be produced. For example, measurement data of a plaster model may be used at the time of designing the three-dimensional shape model of the new full dentures by CAD.

### EXAMPLES

The present invention is described more concretely hereinafter by Examples, but the present invention is not limited to the following Examples provided that the gist thereof is not exceeded.

### Example 1

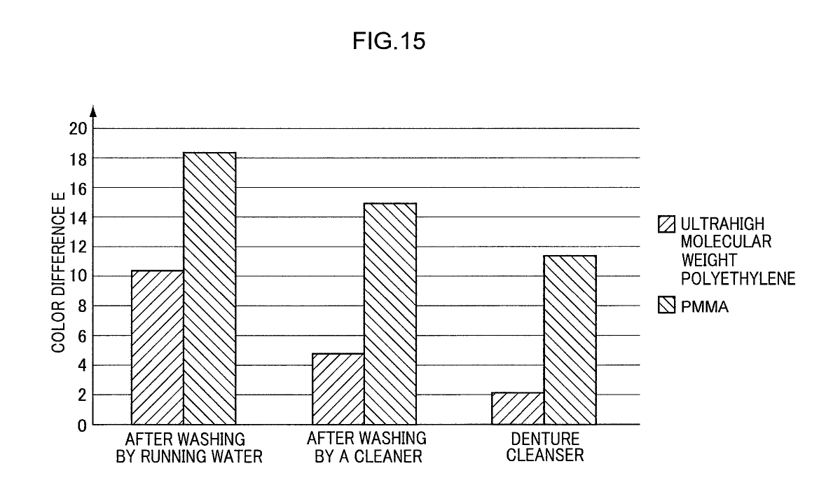

For the ultrahigh molecular weight polyethylene (PE-UHMW) used as the resin for the base of the removable denture of the present invention, a parallelepiped test piece of 5 mm×10 mm×2 mm was readied. The test piece was cut-out from a molded product of the product name “THYLLENE” manufactured by Quadrant EPP Japan. The weight average molecular weight of the PE-UHMW was around 5,000,000, and the test piece was molded by compression molding. By using the prepared test piece, evaluation of the anti-fouling performance was carried out by the method described hereinafter. The results are shown in FIG. 15.

### Comparative Example 1

For the poly(methyl methacrylate) (PMMA) used as the resin for the base of the conventional removable denture, a plate-shaped test piece of 5 mm×10 mm×2 mm was readied. The test piece was fabricated by injection molding by using the product “ACRON” manufactured by GC Corporation. By using the prepared test piece, evaluation of the anti-fouling performance was carried out by the method described hereinafter. The results are shown in FIG. 15.

(Method of Evaluating Anti-Fouling Performance)

The evaluation of the anti-fouling performance of each test piece was carried out by a coloring test in accordance with immersion in a curry solution. A curry solution in which 10 g of curry power was dissolved in 50 ml of distilled water was used as the immersion liquid. “S&B spicy curry powder” manufactured by S&B Foods Inc. was used as the curry powder.

The respective test pieces prepared in Example 1 and Comparative Example 1 were immersed for 90 hours at ordinary temperature in the above-described curry solution, and, after immersion in the curry solution, washing was carried out. There were two types of washing conditions that were washing by running water and immersion washing in a dish detergent. The kitchen detergent “JOY” manufactured by Proctor and Gamble Japan was used as the dish detergent, and immersion washing was carried out by immersion for 1 hour in an 0.5 wt % aqueous solution.

Further, the respective test pieces prepared in Example 1 and Comparative Example 1 were immersed for 216 hours at ordinary temperature in the above-described curry solution, and, after immersion in the curry solution, washing by a denture cleanser was carried out. The denture cleanser “TUFDENT” manufactured by Kobayashi Pharmaceutical Co., Ltd. was used as the cleaner, and the test piece was immersed for 22 hours in an aqueous solution in which one tablet of “TUFDENT” was dissolved in 150 ml of water in accordance with the usage method, and immersion washing was carried out.

Color difference ΔE of the test piece before and after immersion (washing) was measured by a color difference meter. At the time of measurement, a white paper was disposed behind the test piece and used as a substitute for a reference white plate. The “color reader CR-13” manufactured by Konica-Minolta was used as the color difference meter. The color difference ΔE expresses the distance between two points on a color space coordinate, when the colors of the test piece before and after immersion are made into coordinates as two points on a color space coordinate in accordance with the L*a*b* color system. A greater value of the color difference ΔE means the greater the extent of coloring.

(Results of Evaluation of Anti-Fouling Performance)

FIG. 15 is a graph showing the results of evaluation of the anti-fouling performance of each test piece.

When washing by running water was carried out after immersion in the curry solution, at the test piece made of PMMA relating to Comparative Example 1, ΔE=18.3660012, whereas, at the test piece made of PE-UHMW relating to Example 1, ΔE=10.48236615. It can be understood that, at the test piece relating to Example 1, as compared with the test piece relating to Comparative Example 1, the value of ΔE is small, and the extent of coloring markedly decreases to around 60% of the Comparative Example. Namely, it can be understood that, at the test piece relating to Example 1, fouling substances can be easily removed by water washing, and it is difficult for fouling substances themselves to adhere.

When immersion washing by dish detergent was carried out after immersion in the curry solution, at the test piece made of PMMA relating to Comparative Example 1, ΔE=14.9969997, whereas, at the test piece made of PE-UHMW relating to Example 1, ΔE=4.75394573. It can be understood that, at the test piece relating to Example 1, as compared with the test piece relating to Comparative Example 1, the value of ΔE is small, and the extent of coloring markedly decreases to around 30% of the Comparative Example. Namely, it can be understood that, at the test piece relating to Example 1, it is difficult for fouling substances to adhere, and even if fouling substances do adhere, the fouling substances can be easily removed by dish detergent.

When immersion washing by a denture cleanser was carried out after immersion in the curry solution, at the test piece made of PMMA relating to Comparative Example 1, ΔE=11.30928822, whereas, at the test piece made of PE-UHMW relating to Example 1, ΔE=2.071231518. It can be understood that, at the test piece relating to Example 1, as compared with the test piece relating to Comparative Example 1, the value of ΔE is small, and the extent of coloring markedly decreases to around 20% of the Comparative Example. Namely, it can be understood that, at the test piece relating to Example 1, it is difficult for fouling substances to adhere, and even if fouling substances do adhere, the fouling substances can be easily removed by denture cleanser.

As described above, as is clear from the results of the coloring test by the immersion in the curry solution, at the test pieces made of PE-UHMW relating to Example 1, as compared with the test pieces made of PMMA relating to Comparative Example 1, it can be understood that fouling substances can be easily removed by water washing, and it is difficult for fouling substances themselves to adhere. Further, even if fouling substances do adhere, the fouling substances can be easily removed by dish detergent or denture cleanser.

In the above description, evaluation of the anti-fouling performance of each test piece was carried out by a coloring test by immersion in a curry solution. The coloring of the denture due to the curry solution corresponds to protein adhering to the denture surface. When protein is adhering to the denture surface, coloring substances and bacteria further adhere thereto, which leads also to propagation of bacteria within the oral cavity. Namely, the above-described results of evaluation of the anti-fouling performance not only show that the resin base and the removable denture fabricated of PE-UHMW have excellent anti-fouling performance, and show that they have an excellent antibacterial property.

Further, even if a resin base and removable denture, that are fabricated of PE-UHMW whose “impact strength” and “bending strength” are high, receives an impact due to dropping or the like, they are difficult to break as compared with a resin base denture made of PMMA. At the same time, as described above, at a resin base and removable denture that are fabricated of PE-UHMW, it is difficult for fouling substances to adhere, and staining is difficult. Namely, a removable denture having a resin base fabricated of PE-UHMW and a removable denture fabricated of PE-UHMW exhibit excellent durability.

1. A removable denture comprising: a denture base that is made of ultrahigh molecular weight polyethylene and is formed in a predetermined shape by a molded object of ultrahigh molecular weight polyethylene being cut; and artificial teeth that are arrayed at the denture base

2. The removable denture according to claim 1, wherein the artificial teeth are adhered to recesses for an artificial teeth array that are formed in a surface of the denture base.

3. The removable denture according to claim 2, wherein the artificial teeth are resin teeth made of acrylic resin, and after at least the recesses of the denture base are surface-modified so as to be able to adhere with acrylic resin, the artificial teeth are adhered to the surface-modified recesses.

4. The removable denture according to claim 3, wherein the recesses of the denture base are surface-modified by impregnating, in the recesses, an impregnant having affinity with respect to ultrahigh molecular weight polyethylene, introducing hydrophilic groups into a surface of the ultrahigh molecular weight polyethylene that has been impregnated with the impregnant, and graft polymerizing a hydrophilic monomer at the surface of the ultrahigh molecular weight polyethylene at which the hydrophilic groups have been introduced.

5. The removable denture according to claim 3, wherein the acrylic resin is poly(methyl methacrylate) (PMMA).

6. A removable denture comprising a denture base and artificial teeth arrayed at the denture base, wherein the denture base and the artificial teeth are formed integrally in a predetermined shape by cutting a molded object of ultrahigh molecular weight polyethylene being cut

7. The removable denture according to claim 1, wherein a water absorption rate of the ultrahigh molecular weight polyethylene is less than or equal to 0.01 wt %.

8. A method of producing a removable denture that produces the removable denture according to claim 1, the method comprising steps of:
forming the denture base into the predetermined shape by cutting a molded object of ultrahigh molecular weight polyethylene on the basis of three-dimensional shape information of the denture base;
surface-modifying recesses for an artificial teeth array, that are formed in a surface of the denture base, so as to be able to adhere with acrylic resin; and
adhering the artificial teeth to the surface-modified recesses.

9. The method of producing a removable denture according to claim 8, further comprising steps of:
carrying out imaging of an old denture after correction at which a form of a mucosal surface and an occlusion height have been corrected, and acquiring imaging data of the old denture after correction
carrying out imaging of the artificial teeth, and acquiring imaging data of the artificial teeth;
displaying a three-dimensional image of the old denture after correction on the basis of the imaging data of the old denture after correction, displaying a three-dimensional image of the artificial teeth on the basis of the imaging data of the artificial teeth, carrying out optimization of an artificial teeth array and a form of a mucosal surface in the displayed three-dimensional images, and acquiring three-dimensional shape information of a new denture on the basis of the displayed three-dimensional image of the new denture; and
removing artificial teeth from the new denture in the displayed three-dimensional image of the new denture, and acquiring three-dimensional shape information of a denture base of the new denture on the basis of the displayed three-dimensional image of the denture base of the new denture.

10. A method of producing a removable denture that produces the removable denture according to claim 6, the method comprising a step of:
forming the denture base and the artificial teeth integrally in the predetermined shape by cutting the molded object of ultrahigh molecular weight polyethylene, on the basis of three-dimensional shape information of the denture having the denture base and the artificial teeth.

11. The method of producing a removable denture according to claim 10, further comprising steps of:
carrying out imaging of an old denture after correction at which a form of a mucosal surface and an occlusion height have been corrected, and acquiring imaging data of the old denture after correction;
carrying out imaging of the artificial teeth, and acquiring imaging data of the artificial teeth;
displaying a three-dimensional image of the old denture after correction on the basis of the imaging data of the old denture after correction, displaying a three-dimensional image of the artificial teeth on the basis of the imaging data of the artificial teeth, carrying out optimization of an artificial teeth array and a form of a mucosal surface in the displayed three-dimensional images, and acquiring three-dimensional shape information of a new denture on the basis of the displayed three-dimensional image of the new denture; and
acquiring three-dimensional shape information of the denture having the denture base and the artificial teeth, on the basis of the displayed three-dimensional image of the new denture.

12. (canceled)

13. (canceled)

14. (canceled)

15. (canceled)

16. A method of producing a removable denture that produces a removable denture having a denture base and artificial teeth that are arrayed at the denture base, the method comprising steps of:
forming a resin base of a predetermined shape by cutting on the basis of three-dimensional shape information of the denture base;
surface-modifying recesses for an artificial teeth array, that are formed in a surface of the resin base, so as to be able to adhere with resin teeth; and
adhering the resin teeth to the surface-modified recesses.

17. The method of producing a removable denture according to claim 16, further comprising steps of:
carrying out imaging of an old denture, and acquiring imaging data of the old denture;
displaying a three-dimensional image of the old denture on the basis of the imaging data of the old denture, and displaying a three-dimensional image of artificial teeth on the basis of data of only the artificial teeth, and acquiring three-dimensional shape information of a new denture on the basis of a three-dimensional image of the new denture that is displayed by the three-dimensional image of the old denture and the three-dimensional image of the artificial teeth; and
removing artificial teeth from the new denture in the displayed three-dimensional image of the new denture, and acquiring three-dimensional shape information of a denture base of the new denture on the basis of the displayed three-dimensional image of the denture base of the new denture.

18. The method of producing a removable denture according to claim 16, further comprising steps of:
carrying out imaging of the artificial teeth, and acquiring imaging data of only the artificial teeth; and
carrying out optimization of the artificial teeth array and a form of a mucosal surface in a three-dimensional image that is displayed by a three-dimensional image of an old denture and the three-dimensional image of the artificial teeth, and displaying the three-dimensional image of the new denture.

19. The method of producing a removable denture according to claim 17, further comprising steps of:
carrying out imaging of the artificial teeth, and acquiring imaging data of only the artificial teeth; and
carrying out optimization of the artificial teeth array and a form of a mucosal surface in a three-dimensional image that is displayed by a three-dimensional image of an old denture and the three-dimensional image of the artificial teeth, and displaying the three-dimensional image of the new denture.
